(19) United States
(12) Patent Application Publication
(10) Pub. No.: US 2011/0191372 A1
(43) Pub. Date: Aug. 4, 2011

(54) TRIBE OR GROUP-BASED ANALYSIS OF SOCIAL MEDIA INCLUDING GENERATING INTELLLIGENCE FROM A TRIBE'S WEBLOGS OR BLOGS

(76) Inventors: Howard KAUSHANSKY, Nederland, CO (US); Ted V. Kremer, Boulder, CO (US); Nicolas Nicolov, Boulder, CO (US); William A. Tuohig, Boulder, CO (US); Richard Hansen Wolniewicz, Longmont, CO (US)

(21) Appl. No.: 13/014,576

(22) Filed: Jan. 26, 2011

Related U.S. Application Data
(63) Continuation of application No. 12/038,692, filed on Feb. 27, 2008, now abandoned.
(60) Provisional application No. 60/904,655, filed on Mar. 2, 2007.

(51) Int. Cl. G06F 17/30

(52) U.S. Cl. 707/776; 707/E17.014

(57) ABSTRACT

A computer-based method for generating intelligence from social media data, such as blog data, that is publicly available on the Internet. A server is provided that runs a tribe analysis tool, and the method includes accessing a set of the social media data with the tribe analysis tool. The social media data is associated with a plurality of network users or authors. The method continues with operating the tribe analysis tool to identify members of a tribe from the authors by processing the set of social media data to determine the authors having associated portions of the social media data that satisfies tribe membership criteria. Common interests for the identified members of the tribe are determined by processing the social media data associated with the tribe authors. A report is generated for the tribe that includes information related to the set of common interests and additional generated tribe-based intelligence.

### CROSS-REFERENCE TO RELATED APPLICATIONS

This application claims the benefit of U.S. Provisional Application No. 60/904,655 filed Mar. 2, 2007, which is incorporated herein by reference in its entirety.

### BACKGROUND OF THE INVENTION

1. Field of the Invention

The present invention relates, in general, to analysis of electronic or digital information or data accessible on a network such as the Internet, and, more particularly, to computer software, hardware, and computer-based methods for analyzing social media such as blogs, message boards, and the like to extract information or intelligence from postings or published documents/content of particular groups or sets of authors (e.g., bloggers and the like).

2. Relevant Background

With the rapid expansion of the Internet and other communications networks, there has been a dramatic increase in the amount of publicly available information and data that can be used in performing market research. For example, there has been a growing interest in obtaining marketing information and other intelligence by analyzing this online information or “social media” such as to determine opinions of buyers on particular products, on a company's brand, on a new design, and the like or, in the political arena, to determine which issues are important to voters and which candidates are popular with these or other voters. Nearly any information available online may be mined for such intelligence and social media may be considered a broad term that encompasses postings to weblogs or blogs (e.g., mining the blogosphere), discussion in online chat services, information published on a message board, postings in Usenet groups or provided in message services, feedback on product review and other websites such as search provider sites or the like, public messages in other network communication streams, and other online data typically accessible over the network. Intelligence mining typically includes collecting the online data and then analyzing it to identify trends, posters' or authors' likes and dislikes, and other information.

While the potential value of this online information or data in social media has often been recognized, many of the existing tools for mining social media have only had limited successes and have not been widely adopted. Often, existing tools tend to try to apply traditional marketing analysis tools to the Internet and growing social media applications without recognition that the information is often unstructured and rapidly changing with authors often making many postings in one day. Hence, there remains a need for improved tools for mining online social media such as blogs to perform market research and otherwise generate useful intelligence including interests, needs, and sentiments of a company's target market, a politician's voter base, and the like.

In commerce, public administration, and a variety of other fields that perform market research, conventional analysis approaches are used to access opinion information. These more conventional approaches may generally involve polling or surveying in person, by mail or telephone. A survey participant may participate in a focus group and/or be mailed a standard survey form to complete and return by mail or an agent of the provider may call a participant so that the survey questions may be answered over the telephone. These conventional approaches have been applied to the Internet by sending surveys and polls via e-mail, by pushing questionnaires on website visitors, asking online purchasers to provide demographic information, and the like. However, online polling and surveying has often been ineffective with Internet users often refusing to complete such surveys or inaccurately responding to polls and questionnaires or simply deleting e-mail as spam or leaving websites asking for too much information.

Further, even when such survey-type data is gathered by online techniques, performing surveys and their analysis is often inaccurate and inefficient, and analysis often takes considerable time to collect and process. For example, a traditional in-person or online survey, focus group, or direct/e-mail survey may take months before analysis is complete and a final report is issued to an interested client or sponsor of the survey. Computer-administered surveys may improve speed and efficiency by automating some processes. However, computer-administered surveys often fail to assess a variety of implicit characteristics of the response and/or respondent that a human survey specialist could imply from the tone, content, and manner in which the response to a particular question is given. Moreover, computer administered surveys are subject to the same biases and errors introduced by other survey techniques that are based on prompting or soliciting responses. Additionally, survey responses are inherently influenced by the form of the questions or manner of delivering questions while administering the survey. For example, the form of a question may explicitly or implicitly constrain the range of responses, or lead a respondent towards or away from a particular response. These biases are often unintentional and therefore difficult to compensate for when analyzing results. Hence, to obtain accurate results requires great expense of having polling specialists generate questions and using highly trained personnel or sophisticated software to administer each survey.

Other traditional approaches include basket analysis that includes analyzing the purchases of a shopper. The items in their basket may be used to generate market research or intelligence about brands and products. For example, basket research may be used to conclude that buyers of soda also purchase certain types of cereal products or purchasers of diapers in convenience stores often also purchase beer. This information can then be used to direct advertising and modify store locations of goods to encourage such correlated purchases. Similar shopping basket analysis has been applied by many online stores such as sellers of books, music, movies, and the like. This data may be used to make recommendations to the return customer based on their prior searches or to make recommendations for directed advertising based on customers' purchases (e.g., buyers of “X” also often buy “Y”). Such information collection and analysis has been helpful in creating additional sales, but it is typically a very isolated snapshot of that buyer's interests, likes, and dislikes as the online seller is unaware of other online activities of their buyers such as their purchases at other online stores or their postings to social media (e.g., “I bought this product from GoProducts.com but I got terrible service and I hate the product, too.”)

Hence, there remains a need for improved methods and systems for analyzing information available over networks such as the Internet. Preferably, such methods and systems would be useful for collecting unstructured data such as that available via social media such as blogs and for creating intelligence that can be used or directed to provide market and other research of a particular population.

### SUMMARY OF THE INVENTION

To address the above and other problems, the present invention provides methods and systems for performing analysis of content or social media data provided or posted by sets or groups (e.g., “tribes”) of online authors or contributors of content in social media such as blogs, online forums, messaging services, web sites, and the like. The tribes are identified based on one or more selection criteria (e.g., their age, gender, political beliefs, hobbies, and the like), and social media data (such as blog entries and the like) contributed or posted by the tribe members is collected and then analyzed to identify common interests of the tribe. Further, analysis of the tribe's data may be performed to gain additional intelligence (such as their likes and dislikes, their brand loyalty, their political leanings, and so on). The tribe analysis of the present invention provides entities such as businesses, political organizations, governments, and more the ability to discover the common interests of people who share a common characteristic(s) and/or interest(s). In the past, gathering such data would have been difficult, but the inventors recognized that the recent robust contribution by individuals to social media such as blogs provides an amount and detail of publicly available information that is useful for determining common interests amongst groups of these online authors. The data is typically unstructured by the generation of tribes to aggregate select portions of the data when combined with analysis methods allows the common interests of the tribes to be determined.

More particularly, a computer-based method is provided for generating intelligence from social media data such as blog entries, message board postings, or the like that is publicly available on the Internet or other communications network. The method includes providing a server running a tribe analysis tool on a digital communications network and then accessing a set of social media data with the tribe analysis tool. The social media data is associated with a plurality of network users or authors. The method may continue with operating the tribe analysis tool to identify members of a tribe from the plurality of authors by processing the set of social media data to determine the authors having associated portions of the social media data that satisfies or matches a set of tribe membership criteria. The method continues with determining a set of common interests for the identified members of the tribe such as by processing a subset of the social media data associated with the authors who are the members of the tribe. Then a report is generated for the tribe that includes information related to the set of common interests.

In some embodiments, the tribe analysis tool(s) may be provided as software provided in computer readable medium that is useful for performing analysis of data that is available/accessible over a network, such as in one or more social media systems (e.g., blogs, online forums, messaging service, web sites, or the like). The computer readable medium may include computer readable program code devices that are configured to cause a computer to effect retrieving social media data from memory accessible via the network (e.g., date found in one or more web logs, on message boards, in online forums, and the like). Code devices may also be included that cause the computer to apply membership criteria to the retrieved social media data to identify a subset (or “tribe”) of authors of the retrieved social media data. Code devices may also be used to cause the computer to identify and store in memory a portion of the retrieved social media data that was authored by or is associated with the subset of authors. Further, code devices may be included to cause the computer to process the aggregated portion of the social media data so as to determine a set of common interests of this subset of authors. The determination of common interests may include first determining interests for each of the authors and then, second, comparing or processing these interests to see which ones are common amongst the subset or tribe. In other cases, the determination of common interests includes aggregating posts social media data associated with the entire tribe or subset of authors and then determining the interests of the aggregated data set (e.g., in a supervised and/or an unsupervised manner). Code devices may also be provided to cause the computer to determine a sentiment of the subset of authors for each of the common interests, determining a sentiment of the larger group of authors that provided the retrieved social media data, and then comparing these two sentiments to determine when the authors of the subset or tribe differ significantly from the larger group or general population of online authors. Code devices may further be included that cause the computer to determine a level of concern of the tribe members or subset of authors for one or more topics by processing the aggregated portion of the social media data (e.g., a set of web log or other media data that is retrieved for or corresponds to a certain period of time such as the past three months or the like).

### BRIEF DESCRIPTION OF THE DRAWINGS

FIGS. 1A and 1B are a functional block diagram of a computer system or network according to an embodiment of the invention showing use of a social media analysis server that is running a tribe analysis tool to gather intelligence from data available in social media systems such as blogs, message boards, and other forums and/or unstructured online data;

FIG. 2 is a flow diagram illustrating an embodiment of a tribe or online interest group analysis such as may be achieved during operation of the system of FIG. 1;

FIG. 3 illustrates a graph or representative screen shot of a tribe analysis report illustrating an exemplary tribe (e.g., one identified based on the two-part selection criteria of “mother” and “use cloth diapers”) along with a set of determined common interests for the tribe; and

FIG. 4 illustrates in graph form (such as may be used in a generated report) the tracking or trending of a tribe make up over time showing changing size of the tribe and changing proportion of tribe members (or authors) in various subsets or subtribes.

### DETAILED DESCRIPTION OF THE PREFERRED EMBODIMENTS

The present invention is directed to computer-based methods and systems for generating market research information and other types of intelligence by processing posts, messages, or data available in social media on the Internet or another digital communications network(s). Briefly, the invention generally involves identifying a tribe or group of authors or participants of a social media such as a blog, a chat room, a message board/forum, or the like. Such a tribe may be identified based on one or more selection criteria (e.g., men, under thirty years of age, having a particular political party affiliation, or the like), and tribes may be static or change over time and may be inclusive or exclusive (e.g., accept all authors meeting the criteria or accept all authors unless they also meet another excluding/conflicting criteria). Once a tribe is identified, the postings or other social media data for that tribe are gathered or aggregated. Tribe analysis then may proceed with identification of common interests of the tribe (e.g., men under 30 years old that are Democrats share interests in sports cars, baseball, light beer, and the like). Reports may then be generated that include the common interests and other market research or intelligence (such as identified correlations among the interests). These and other features of the tribe analysis functionality of the invention will become clear from the following detailed description with reference to the attached figures.

The functions and features of the invention are described as being performed, in some cases, by “modules” that may be implemented as software running on a computing device and/or hardware. For example, the tribe analysis method, processes, and/or functions described herein and including tribe identification, common interests determination, and tribe data analysis/reporting may be performed by one or more processors or CPUs running software modules or programs such as Boolean algorithms, natural language processing of text in social media data, correlation routines, and the like. The methods or processes performed by each module are described in detail below typically with reference to functional block diagrams, flow charts, and/or data/System flow diagrams that highlight the steps that may be performed by subroutines or algorithms when a computer or computing device runs code or programs to implement the functionality of embodiments of the invention. Further, to practice the invention, the computer, network, and data storage devices and systems may be any devices useful for providing the described functions, including well-known data processing and storage and communication devices and systems such as computer devices or nodes typically used in computer systems or networks with processing, memory, and input/output components, and server devices (e.g., web servers used to serve or host blogs, web sites, message boards, and the like) configured to generate and transmit digital data over a communications network. Data typically is communicated in a wired or wireless manner over digital communications networks such as the Internet, intranets, or the like (which may be represented in some figures simply as connecting lines and/or arrows representing data flow over such networks or more directly between two or more devices or modules) such as in digital format following standard communication and transfer protocols such as TCP/IP protocols.

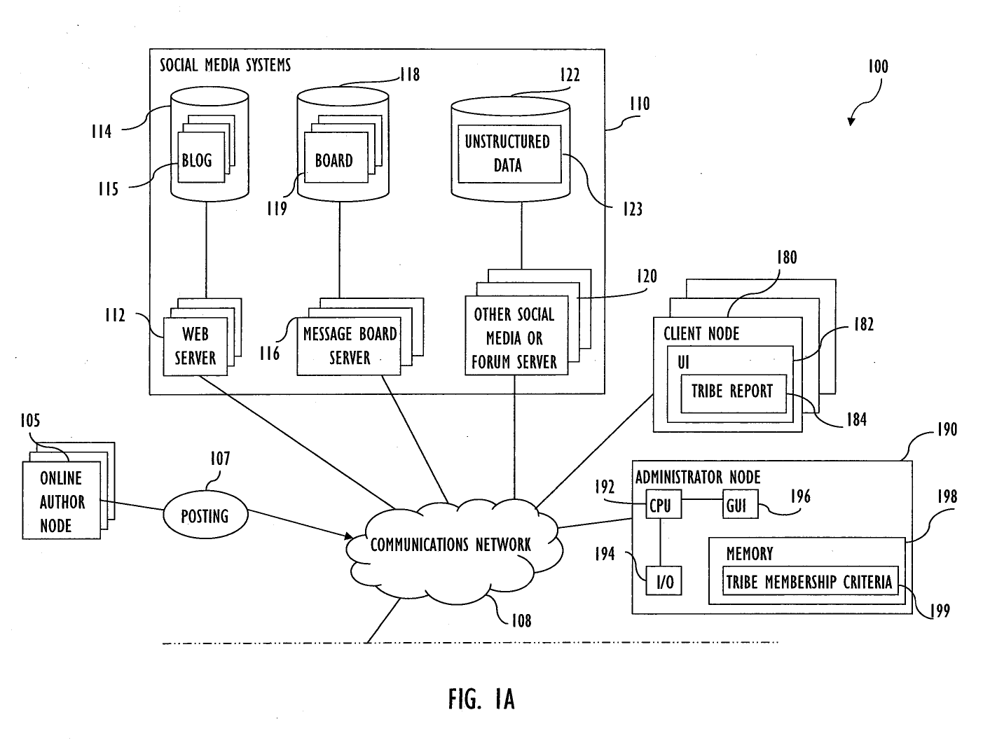

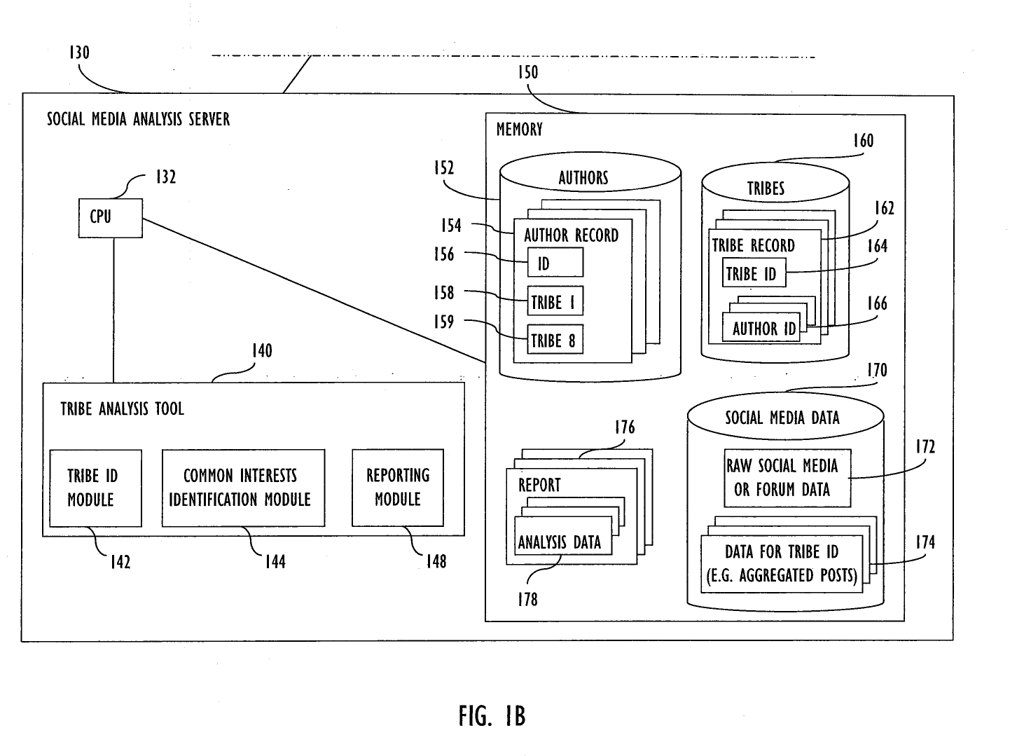

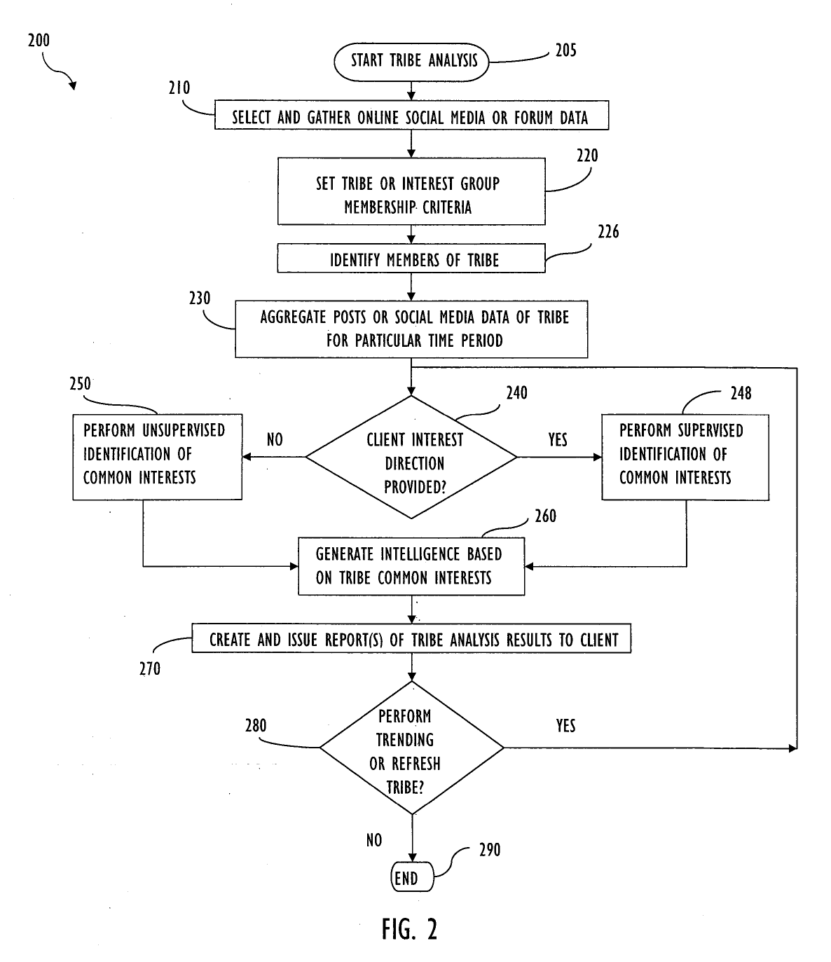

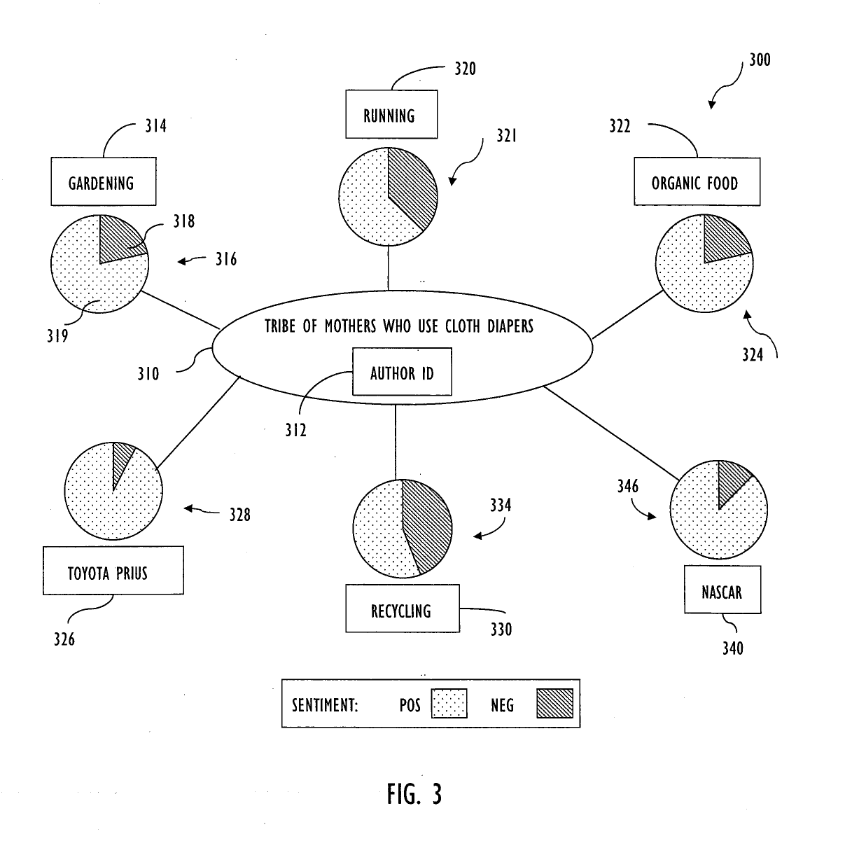

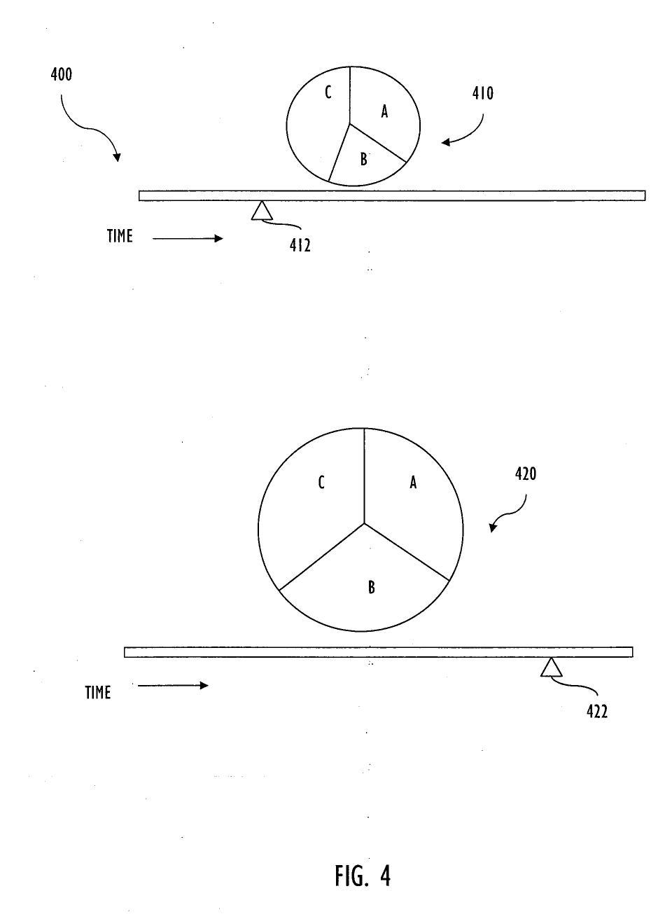

The following description begins with a description of one useful embodiment of a computer system or network 100 with reference to FIGS. 1A and 1B that can be used to implement the tribe analysis processes of the invention. Representative processes are then discussed in more detail with reference to the method 200 of FIG. 2 with support or more detail provided by the screen shots/report of a user interface or printed/transmitted documents shown in FIGS. 3 and 4 that may be generated during operation of the system 100 of FIGS. 1A and 1B or another system according to the invention. The description also explains the advantages and applications for the tribe analysis according to the invention.

Prior to turning to FIGS. 1A and 1B, it may be useful to explain that the inventors recognized that in increasing numbers individuals (interchangeably, tribe members, users, or authors) are contributing to and participating in social media on the Internet (or other communications networks). Such social media may include, for example but not as a limitation, blogs, message boards, chat room and other forums, e-mail and other electronic messaging such as text messaging, instant messaging, audio messaging, and the like, video clip posts/sites, image sharing sites, and so on with some social media data sources including multimedia content and often including more than one type of content (i.e., heterogeneous in content). These destinations or social media allow people to express their likes, dislikes, opinions, and perceptions such as regarding products, services, brands, entertainment, politics, and other topics of interest with which they interact or otherwise observe in society. The inventors understood that much of this social media data including blog entries, forum input, and message board postings are often in the public domain. The inventors further recognized that it would be desirable and useful to collect and analyze this data for marketing, societal research, and other purposed but there were no existing analysis tools that could fill this need. With this in mind, the inventors created the tribe analysis method/system described herein. The tribe analysis provides unique insights and data analysis by aggregating information from the individual users or authors to allow intelligence to be observed from the totality of interests of a tribe member (or individual) rather than a single action (e.g., basket analysis or a poll response) and/or by aggregating the totality of observed opinions and perceptions of many authors that share a common trait (or satisfy one or more tribe selection criteria).

FIGS. 1A and 1B illustrates a simplified functional block diagram of an exemplary computer system or network 100 and its major components (e.g., computer hardware and software devices and memory devices) that can be used to implement an embodiment of the present invention. As shown, the system 100 includes a plurality of online author nodes 105 communicatively linked to a digital communications network such as the Internet 108. In practice, the nodes 105 are any electronic device that allows an individual, user, blogger, author, or the like to provide content or data (such as the shown posting) 107 over the network 108 to one or more social media systems 110. Typically, the nodes 105 are devices such as computers (desktop, laptop, notebook, or other computers), PDAs, cell/wireless phones, and the like that are configured for wired and/or wireless communications with over the network 108 with the media systems 110. The social media systems 110 may similarly be a variety of network devices adapted for serving and/or storing social media data, and, in some cases, the systems 110 includes components for providing blogs (e.g., a web server 112 and memory or data stores 114 storing blogs or blog entries 115), forums or message boards (e.g., web or message board servers 116 and memory or data stores 118 storing board documents, messages, posting, and the like 119), and other social media such as messaging surfaces, Usenet, web sites, and the like (e.g., media servers 120 linked to memory or data stores 122 storing corresponding unstructured data 123).

Significantly, the system 100 further includes a social media analysis server 130 also linked to the social media systems 110 via the network 108. This allows the analysis server 130 to operate to mine (gather and process) the social media data 115, 119, 123 provided by the users of the author nodes 105. To this end, the analysis server 130 includes a process or CPU 132 that runs a tribe analysis tool 140 and controls data storage and retrieval from memory 150 (which may be local as shown or remote such as accessible over the network 108 or otherwise). Operation of the tribe analysis tool 140 is described in more detail below but, briefly, the tool 140 includes a tribe ID module 142 for identifying a plurality of authors to include in a tribe (such as based on tribe membership criteria 199). The tool 140 also includes or runs a module 144 for determining the common interests of one or more tribes identified by module 142 (such as via supervised or unsupervised processing described below in more detail). The tool 140 further includes an analysis and reporting module 148 that functions to gather/generate intelligence (such as market information, correlation between a tribe's common interests, a comparison of two or more tribes and their interests, and the like) and create tribe analysis reports that can be provided in a hard or print version or more typically via the network 108 to a client node 180 as shown in the user interface 182 with a tribe report 184.

During operation of the tribe analysis tool 140, the tool 140 stores data that it gathers and creates. Specifically, memory 150 is used to store a general database 152 of the authors or users of nodes 105 (e.g., a listing of bloggers and others that are acting to post or provide content or data 115, 119, 123 in the social media system 110). The author records 154 may include an author ID 156 that provides a unique identifier for the individual or user of node (such as a password, message board handle, blog URL, or the like) and after operation of the tribe ID module 142 the record 154 may be updated to indicate which tribes the author belongs to or has been assigned by module 142 with tribe ID fields 158, 159. Note, an author may not belong to any tribe as only the authors meeting or satisfying a tribe definition are assigned to the identified or corresponding tribe. After identification of a tribe, the tribe ID module 142 also stores a tribe record 162 in a tribes database 160 in memory 150 that may include a tribe identifier or ID 164, and the record 162 generally will also include a listing of all the authors or the corresponding author IDs 166, that have been determined to belong to this particular tribe. The analysis tool 140 (or another module not shown) acts to retrieve or gather raw social media or forum data as shown at 172 in social media data database or, in some cases, this data may just be accessed as needed by tool 140 over network 108.

Once a tribe is identified, the analysis tool 140 (or another module, not shown) may act to process the raw social media or forum data 172 to aggregate the data that is relevant for that tribe (i.e., all the postings, blog entries, message, or the like for the members or authors 154 of the tribe as indicated by a tribe record 162). The source of the data 174 may be one or more types of social media such as blogs and chat rooms or may be one type of media such as blogs or an online messaging service. The tribe data 174 also may include data from more than one source within a selected media type such as blog entries by a single author over two or more blogs. The analysis tool 140 may then run the module 144 to determine common interests of a tribe by processing the data 174 for the corresponding tribe 162. Again, this may be unsupervised or supervised (e.g., based upon client interest direction or queries provided by a client such as via node 180 over network 108). The common interests may be included in the analysis data 178 in a report 176 generated by a reporting module 148 of the analysis tool 148 and the reports 176 are often transmitting over network 108 to client nodes 180 for display as report 184 on UI 182 of client node 180. As discussed below, the analysis data 178 of a report 176 may include a variety of other information or intelligence such as the aggregated sentiment of the tribe members regarding a particular common interest, changes in the tribe size and/or make up over time, changes of the tribe sentiment over time, possible co-branding opportunities, and the like.

The system 100 also is shown to include at least one administrator node 190 linked to the analysis server 130 directly or as shown via the network 108. The node 190 again may be any of a number of computer or electronic devices such as a PC or other computer device, a wireless device such as a PDA, or the like. The node 190 is typically operated by a user or system administrator to selectively run the tribe analysis tool 140 such as to analyze social media data, e.g., in response to a request from a client operation a client node 180 to submit a request for market research. To this end, the node 190 may include a CPU 192 to manage operation of I/O devices 194 (such as a keyboard, mouse, touch screen, voice recognition data entry, and the like), a user interface 196, and/or memory 198. During use, an administrator may supervise the identification or determination of common interests of a tribe by entering interests to verify as common among the tribe. Also, an administrator may enter tribe membership criteria 199 for use by the tribe ID module 142 of analysis tool 140 in determining authors or users of node 105 (or posters, bloggers, and the like) for inclusion in a particular tribe or group of content contributors. The membership criteria 199 may be chosen by the administrator or, in many cases, the criteria may be provided by a client via operation of the node 180 such as in a market or tribe analysis request, e.g., a request to find and/or analyze the common interests of a particular portion of the participants in social media such as for marketing analysis or other reasons.

FIG. 2 illustrates an exemplary tribe analysis 200 such as would occur during operation of the system 100 of FIGS. 1A and 1B. Generally, tribe analysis 200 is a multi-step process for analyzing social media data aggregated for members of a tribe. The analysis 200 is started at 205 such as designing an analysis project by selecting a set of social media to use in identifying tribes and analyzing their aggregated online content. The starting step 205 may also include installing a tribe analysis tool on a server and choosing modules and corresponding analysis programs and routines to provide a desired functionality (e.g., how to determine whether or not a common interest exists for a set of online authors or a tribe). For example, the tribe analysis 200 may be used to identify common likes, dislikes, interests, opinions, perceptions, and the like (which may be termed “common interests”) of a group of people or authors who participate in one or more social media such as provide or participate in one or more web logs. As a quick overview, the analysis 200 may include determining an element of interest to identify a group of individuals providing content online (i.e., a tribe); identifying common interests of individuals in the tribe; and reporting on the common interests of the tribe and other intelligence gained from the analysis of these determined common interests.

The method 200 continues at 210 with selecting and gathering online social media or forum data. This may include choosing one or more social media systems to monitor and/or analyze and then collecting the raw content or data of such systems. For example, it may be determined that the analysis 200 will concentrate on blogs and a particular type of message forum. Step 210 may then involve retrieving entries or postings available in the public domain blogs and message forms. In another example, the analysis 200 may be designed to collect data from chat rooms and particular sets of web sites, and this data would be gathered at 210. As can be appreciated, the particular type of social media chosen for providing social media data is not limiting. In some cases, though, the social media is chosen such that the data collected at step 210 is relatively unstructured and/or unfocused. In other words, one advantage of the inventive method described herein is that the collected data is more likely to cover more than one narrow topic or interest as may be the case of a single message forum. So, it is often the case where it is desirable to collect information from blogs where authors are more likely to provide content on two or more subjects and to provide indications of their opinions or their positive/negative sentiments toward such topics.

At step 220, the method 200 includes setting or selecting the tribe or interest group membership criteria. A tribe may be identified as people (or online authors) who hold a common opinion (e.g., authors who approve of the current political leader or like a particular brand or the like), have a common interest (e.g., provide links in their blog to a similar site or posted content that shows they like to play golf, they drive hybrid cars, they plan to vote for a candidate, or the like), have a similar physical or demographic characteristic (e.g., Gen Y, male, same residential geographic location, or the like), or a combination of such selection criteria (e.g., Gen X females who like hybrid vehicles and vacations in Mexico). The section criteria may be set or chosen by a system administrator (such as to perform targeted analysis of social media data) or be chosen by a party or client requesting a tribal analysis (such as a company that wants information on individuals speaking or posting information about their product or one of their brands or having postings indicative of their membership in a particular target market).

The invention is not limited to use of a particular selection criteria or set of such criteria, and it is difficult to list all possible criteria. However, the following are some of the criteria or variables that may be used to identify or select authors or individuals to be members of tribes (with examples provided in parentheses): age (e.g., under 20, belonging to Generation Y, and so on); gender (e.g., females); sentiment (e.g., positive or negative opinion on a topic or interest); behavior (e.g., posted more than X times on a topic); mentioned particular phrases (e.g., discussed a political debate in an online posting or entry); bloghost; political affiliation (e.g., Democrat, Republican, Libertarian, or characterization rather than party such conservative, moderate, and so on); religious beliefs or memberships; sexual preferences and characteristics (e.g., heterosexual, homosexual, and the like); race (e.g., Caucasian, Hispanic, African American, and the like); geographical location (e.g., lives in the United States, Canada, Japan, and so on or within a larger or smaller region such as a state, a city, a region, a neighborhood, and so on); similar content to which authors point or link; marital status (e.g., single, married, divorced, widowed, and so on); family size; number of children; role in the blogosphere or other social media (e.g., summarizer, initiator, and the like); centrality/relevance/influence in the blogosphere or other social media (e.g., measure); influencers or trend setters; education (high school, bachelors degree, and so on or where education was obtained such as Harvard graduate); income (e.g., range of household income); occupation; purchasing habits (e.g., early adopter, late adopter, shops only at sales, etc.); social role (e.g., trend setter, follower, and the like); social label (e.g., sports junky, geek, couch potato, and so on); sports interests; sports practice/participation; hobbies; personality (e.g., extrovert, introvert, etc.); brand loyalty; multimedia content (e.g., people with more than 5 pictures on their blog, people with songs on their blog, and so on); metadata (e.g., people with pink background on their social media); and favorite entertainment programs (e.g., people listing TV shows in their social media entries).

At step 226, members (or social media data authors) are identified as belonging to a particular tribe defined by the membership criteria set in step 220. Generally, members are identified by analyzing all or portions of the gathered social media data (e.g., looking at all or a set of blogs) to analyze the interests provided in entries or postings of content on the Internet or in the monitored social media systems. For example, language processing systems may be used to identify the likes, dislikes, interests, opinions, and perceptions (or simply “interests”) of the authors of the collected (or accessed) social media data, and then these interests are compared with the set selection criteria to identify authors who should be selected as members of this tribe. As shown in FIG. 1, a tribe record may be stored along with an ID of each author or member in the tribe. The unique identifier for each member may be collected from the online or public domain information and may be, for example but not as a limitation, a blog URL, a message board screen name, a uniquely assigned identifier, or a method or technique of assigning posted social media data containing interests on the Internet or other network to an individual, an Internet user, or author. For example, a tribe selection criteria may be set as female authors, belonging to Generation Y, that discuss Loyola High School and, then, intelligence such as “Among Gen-Y, female authors discussing Loyola High School, 53 percent discuss ‘unwanted pregnancy’” with “unwanted pregnancy” being a determined or mined common interest (as discussed below with reference to steps 248, 250).

In some cases, the step 226 may involve further classifications and analysis and is not limited to a simple one step identification of tribe members. For example, in some embodiments, a tribe ID module or classifier may be configured to determine if an author belongs to a certain sub-category or not, e.g., for picking the tribe of Democrats and the tribe of Republicans or similar sub-categories. Note, that that method 200 may be repeated to create any number of tribes using differing membership criteria and/or using differing portions of the social media data to identify each tribe, and an individual or author may be identified as a member of more than one tribe based on their posted content. In some embodiments, the steps 220, 226 are performed such that a distinction can be made between explicit (or active) tribes and implicit (or passive) tribes (or explicit or passive membership in a tribe). For example, an explicit tribe may involve members that actively communicate with each other such as “author X interacted directly with author Y” (e.g., X posted on Y′s blog or the like), and X and Y are active members of a tribe. In contrast, an implicit tribe or tribe membership may be where two authors have independently shown a common interest such a determination like “author X and author Y discuss the same topic but they have not interacted directly with each other.” Such explicit and implicit distinctions may be noted in the tribe record and/or with each tribe member or author field in the tribe database. Further, the tribe criteria and identification at 220, 226 may be performed to provide subtribes or additional tribe segmentation. For example, a tribe may be further segmented by criteria such as one or more of the criteria listed above. In practice, a tribe may be generically described by a client (e.g., in their request) or by a system administrator, and then, subtribes may be formed as either automatically clustered groupings or subgroups or clusters that match an additionally or subsequently applied subtribe membership criteria (e.g., of the tribe, which authors/members also “criteria” such as members that mention a particular phrase or show a particular common interest).

The method 200 continues at 230 with aggregating posts or social media data of the tribe for a particular time period, and this aggregated tribe data is typically stored in memory or a data store accessible to the tribe analysis tool/software package. For example, once the unique identifiers are determined for each tribe member, all posts for a period of time (e.g., in the last 3 months, in the past year, during 6 weeks starting last January 1, and the like) for each tribe member are aggregated from online unstructured data stores or from previously gathered raw social media data as shown in FIGS. 1A and 1B. The aggregated data may include the entirety or portions of the content, links, metadata, and other data that is contributed by the tribe member, and the aggregation may be performed by crawling or other techniques.

At 240, it is determined whether a client or other has provided a directed or supervised interest or set of interests. For example, a request may be received to test a tribe to determine if they have a common interest in one or more topics or concerns. If so, the method 200 continues at 248 with a supervised identification of common interests based on the interest direction or input. If not, the method 200 continues at 250 with performing unsupervised identification of common interests of the tribe. In some embodiments, steps 248 and 250 may both be performed on the aggregated data of a tribe to identify common interests. Steps 248 and 250 may involve analyzing the aggregated posts for each of the tribe members using various statistical and linguistic methodologies to determine the interests of each member, and then the interests of each tribe members are processed and compared to one another to determine which of the tribe member interests is a common interest to the tribe (i.e., common interests). In other embodiments, the aggregated posts or collected social media data for the entire tribe is aggregated to create a collective corpus of posts/data for all tribe members, and this corpus of data is analyzed with one or more statistical and linguistic methodologies to determine tribal common interests. In step 248, these methodologies are supervised to analyze whether a specific topic or concept is a common interest of the tribe (e.g., determining if members of a tribe share a common interest in the Denver Broncos). In step 250, these methodologies are unsupervised and rely more on techniques without the introduction of a specific topic or concept to determine a set of common interests for the tribe.

The determination of common interests in steps 248 and 250 is followed by generating additional intelligence at 260, which is often based on the determined common interests. The steps 248, 250, and 260 may be performed in concert, in parallel, and/or in series, and the following discussion generally provides a discussion of tribe analysis. At a high level, the generated intelligence answers the question of what else (besides the selection criteria) do the tribe members have in common. Analysis at step 260 may involve extracting tribal concerns (e.g., are tribe members concerned about one or more of: current affairs, business issues, health, science, nature, technology, entertainment, education, politics, sports, law, travel, autos, issues related to any of the listed selection criteria, or the like). The analysis 260 may involve verb clustering (e.g., why do they mention a topic, what verbs do they use in association with a topic, and the like). The analysis 260 may further involve processing linked content, which may include finding top major link classes. This type of link analysis may allow the intelligence to include link information such as “in Tribe X, 70 percent of the members point to sports, 20 percent point to movie stars, and 10 percent link or point to blog posts of other authors” or the like.

Intelligence gathering or processing of the aggregated tribe data at 260 may also include fishing for evidence such as with a directed search for specific information. This may include extracting specific objects or topics that the tribe members like or dislike (e.g., have positive or negative sentiment toward). For example, the following fishing queries or similar queries may be applied to the aggregated social media data for the tribe members: what do they watch on TV; what are their hobbies; what sports do they like (or do they like a particular sport such as soccer); what do they read (or particularly to they read a particular magazine, newspaper, or book); where do they shop or buy particular goods/services; what kinds of cards do they like; do they smoke; and so on. The tribe analysis at 260 may also include topic penetration in the tribe such as determining for a given external topic (e.g., ecology), what percentage or fraction of the tribe members are discussing the topic.

Step 260 may also include temporal tracking of a topic or a parameter in the tribe such as by determining a measure of topic penetration or another parameter/tribe characteristic over time such as female-male distribution in the tribe over time. Such analysis may also be considered trending (see step 280 of method 200). The analysis 260 may further involve comparing the tribe to a larger group such as the entire blogosphere or a portion of the social media system. For example, it may be significant not only to determine a sentiment of tribe members or a common interest of the tribe but to also determine if that sentiment or common interest varies from a larger online population and, if so, to what amount. For example, in the blogosphere in general, two topics may be mentioned substantially equally (or have the same sentiment) while within a tribe one of the topics may be discussed much more often (or have a much different sentiment applied to the topic/interest). Such tribe versus larger online group allows intelligence such as the following to be created at 260: “In the tribe of midwestern Republicans, 73 percent like NASCAR races while in the blogosphere the percentage is only 39 percent.” This specific example involves sentiment analysis on the blogosphere for the topic “NASCAR,” but more in depth analysis can be performed on the aggregated data for the tribe because is it much smaller in volume/size and requires less time to process. Analysis 260 may also include looking specifically at what the tribe likes (or dislikes) such as by looking for phrases and then assessing sentiment for the phrases for sentiment to allow selection of strong and positive (or negative) sentiment. Step 260 also may include analyzing the language of discussion used by tribe members such as trying to answer the question of how the tribe members' language compares to other online authors' language (e.g., of the same age, of the same sex, and the like), which may be useful to extract jargon of the tribe that may be used for targeted messages/communications such as advertising to the group. Further, the analysis 260 may involve determining where the tribe goes and where they spend time (e.g., where do they: go to work, go to the supermarket, go to the mall, go to a restaurant, go to the movies, go for vacation, and so on).

The method 200 continues at 270 with creating and issuing reports that include all or portions of the analysis results such as common interests determined at 248, 250 and/or intelligence generated at 260. The reports may be transmitted to requesting clients in the form of a digital report that can be viewed in a user interface and/or printed out and may include textual data providing the results and/or graphical reports, tables, and so on. At 280, the method 200 continues with performing trending of the tribe (such as determining whether the tribe is growing over time, whether the make up of the group is changing, whether the tribes common interests are changing, whether sentiments are changing, and so on) or refreshing the tribe periodically to update its tribe members and, if appropriate their common interests/intelligence (as shown by continuing back to step 240). Otherwise, the method 200 ends at 290 or may be restarted to create and analyze an additional tribe.

FIG. 3 illustrates a portion of a tribe analysis report 300 (e.g., a screen shot of a graph provided in a client or administrator monitor or UI of their network device/node). As discussed with reference to FIG. 2, once the common interests of a tribe have been determined, these common interests can be reported (e.g., substantially “as is”) and/or these tribal common interests may be compared to the common interests of other tribes. For example, the common interests of the tribe of people who like the current president of a country may be compared to the common interests of the tribe of people who like potential candidates to become the next president to determine the similarities and dissimilarities of the two tribes (e.g., what may be deciding issues for a voter and other intelligence). The diagram or report 300 provides information or intelligence regarding a hypothetical tribe of mothers who use cloth diapers 310 shown to have a plurality of authors 312 (although the membership may be hidden or not provide explicitly in the report diagram 300). In this case, the tribe membership criteria required that authors/members be both a mother and someone who uses cloth diapers. Then, a plurality of common interests 314, 320, 322, 326, 330, 340 were determined for the tribe 310 (e.g., gardening, running, organic food, Toyota Prius, recycling, and NASCAR). Additional intelligence gathering or analysis was performed based on these common interests to determine the percentage of the tribe that likes or dislikes each common interest (e.g., a sentiment for each common interest). The sentiment values are shown, in this example, with pie charts 316, 321, 324, 328, 334, 346 with coloring, hatching, or some other technique used to differentiate a positive portion or percentage of the group and a negative portion of the group for each interest (as shown in pie 316 with wedges 318 and 319).

As noted with regard to step 280 of method 200, it may be desirable in some embodiments to report on the composition or make up of a tribe over time. By determining the composition of a tribe at its creation and then comparing it to the composition of the tribe at a later point in time (and then this later time to a yet later time and so on), it can be determined how the make up of members of the tribe changes over time. For example, a tribe with members who have grown home gardens may include 82 percent Boomer Generation females at its creation (or a first time) of the tribe but shift to 70 percent Generation Y females over time (or at a second time). Reporting this change may be important to allow a client or an entity monitoring social media data to update their research and make appropriate decisions such as how best to market to this changing tribe. Similarly, FIG. 4 illustrates a tribe make up report or trending analysis 400. The tribe make up at a first time 412 is shown with pie chart 410 to include subtribes or subgroups A, B, and C. The tribe shown in chart 410 has a certain population or membership total with subtribes A, B, and C each making up a particular proportion or fraction of that overall membership total. Trending or refreshing may be performed to create a similar chart 420 at a later or another time 422. Typically, membership of a tribe will vary over time, and the example of FIG. 4 shows in chart 420 that the tribe has grown in its overall size or tribe membership (e.g., as the size of the chart 420 is greater than chart 410). Further, the fraction or percentage of the subtribes has changed with the chart 420 showing that subtribe B has increased significantly in proportion relative to subtribes A and C. The graph or report 400 may be presented to a client or other requesting entity to allow it to adjust its operations appropriately (e.g., to alter its advertising approach or communication techniques to recognize the overall growth of the tribe and relative greater importance of subtribe B in the tribe).

As discussed above, the creation of tribes and determination of common interests provides a significant amount of data that can be further processed and used to provide intelligence that otherwise was very difficult if not impossible to obtain from the unstructured data of social media. For example, tribes can be compared and contrasted to obtain additional intelligence or information. Specifically, a tribe discussing one political candidate may have their common interests contrasted to a tribe discussing another political candidate (e.g., tribe of people discussing Hillary Clinton may be compared to a tribe discussing John McCain). In another case, a tribe made of listeners of one radio station or viewers of one television station may be compared to a tribe made of listeners of another radio station or viewers of another television station (e.g., listeners of a liberal news channel versus listeners of a conservative new channel and the like). Such tribe comparison can create a wide variety of intelligence such as the following: tribe T discusses topic X while tribe S does not; 65 percent of tribe T discusses topic X while only 12 percent of tribe S does; whenever tribe T members mention topic C (e.g., ecology) they also mention topic D (e.g., reducing our own country's carbon dioxide emissions) while tribe S members do not mention topic C in association with topic D; and other tribe comparisons too numerous to list.

With the above discussion in mind, it may be useful to provide a number of specific applications or implementations of the tribe analysis and intelligence generated from such analysis. Tribe analysis may be useful for co-marketing efforts as it may reveal common interests not previously known by a company providing products and services. This information can be used by the company to establish relationships with other companies offering products and/or services within the common interests to reach people who may be interested in the products or services of either company. In the tribe example of FIG. 3, the makers of the Toyota Prius may discover from this analysis that tribe members also are interested in NASCAR, and they may want to advertise at the NASCAR events or sponsor a NASCAR race team.

Regarding new product enhancements, tribe analysis may reveal common interests not previously known by a company that provides opportunities for development of new and/or enhanced products. For example, users of a particular digital music player may also have an interest in major league baseball, and, based on this information, the maker of the music player may want to provide a video streaming capability to allow purchasers/users of their product to watch televised baseball games. Regarding media planning, tribe analysis may reveal common interests not known that can be used to advertise to or to otherwise communicate/reach people who may not otherwise be reached by an advertiser. For example, if an automobile maker discovered that people who like one of their lines of vehicles also likes gardening, the automobile maker may want to advertise on gardening web sites, on gardening TV shows, and/or in gardening magazines. Regarding tribe marketing, tracking the composition of a tribe over time as discussed above may assist in determining who best to market to the tribe as the tribe composition changes over time. Additional specific, but not limiting, examples of tribe analysis and its generated intelligence/information include educating political representatives on the desires/interests of their constituencies, conflict resolution (e.g., understanding the common interests of two tribes with opposing views on a subject may assist in resolving conflicts), entertainment programming and planning, and many more.

Another aspect of tribe analysis that may be performed in embodiments of the invention, such as with tribe analysis tool 140, to determine tribe dynamics. For example, the tool may determine when an individual is no longer a member of a tribe and, in response, update the tribe membership. A person may have expressed an interest in a topic in the past but may no longer have any interest in the topic, and, as a result, the size, demographics, and make up of the tribe may change over time (again, see FIG. 4). Additional, specific areas or functionality that may be included in a tribe analysis method (or be performed by its software/firmware tools) are described in the following paragraphs.

A tribe may be entirely static, e.g., be based entirely on the set of documents from a given time period, and not be changing over time. Alternatively, a tribe's membership may be static (e.g., be based on documents analyzed at a particular time), but membership may be updated with new documents authored by the same authors after the tribe is initially created. This provides the opportunity to learn new things about tribes over time. In other cases, the tribe's membership may be dynamic. Some embodiments of the tribe analysis method and system allow newly discovered authors to be added to tribes if they are determined to be members and/or allow existing authors to become tribe members if later documents indicate they should be. For instance, if an existing author who has never discussed family mentions in a new post that she is a mother, the author could be added to the “Mothers” tribe, and the author's previous documents considered for inclusion in tribe analysis. Likewise, given a “Hillary Clinton Supporters” tribe, a member who indicates that they intend to vote for John McCain might be removed from the tribe. We may choose to keep earlier documents in the Hillary. Clinton tribe or to remove prior documents from the tribe (and this is a property of the tribe discussed more in the next paragraph).

An author's membership in a dynamic tribe may be persistent or temporary, and it may be tied to a start time or reflective of all time. In one useful example, “Colorado Natives” may be a persistent tribe with no time considerations. Authors either are or are not a Colorado native. Any author identified as a Colorado Native should be added to the tribe, and all documents ever written by that author should be included in the tribe analysis. In contrast, “College Students” is an example of a temporary tribe as authors come and go frequently from the tribe. Embodiments of the tribe analysis method and system may be configured to assess the time range over which someone was a college student and consider documents from that particular time range. In further regard to dynamic tribes, “Mothers” is an example of a persistent tribe whose membership has a specific start point as people become mothers at a given point in time and are always mothers after becoming a mother. In the political arena, “Hillary Clinton Supports” is an example of a tribe that is mutually exclusive with “John McCain Supporters.” The tribe analysis method and system may include documents from the first indication of support for Hillary Clinton through, but typically not including, the first indication of support for any other presidential candidate in the tribe analysis for “Hillary Clinton Supporters.”

In addition to the automated assignment of authors to tribes, as discussed above which was focused on use of a strict membership criteria, some embodiments of the tribe analysis method (and associated systems/tools) may be adapted to consider other mechanisms for tribe membership. In some cases, authors may be annotated to a tribe by a human annotator such as based on human judgment of the same type of factors listed above as tribe membership criteria, rather than on an automated system's assessment (e.g., through a software routine or module applying a query or model) of the same information. In other cases, authors may be modeled into a tribe based on well-known statistical/machine-learning models rather than on (or in addition to) explicit knowledge. For instance, using knowledge of the normal modes of speech of “Colorado Natives” or other tribes, a machine learning algorithm or other routine/module may be used to identify other “Colorado Natives” based on their speech patterns, even if these authors never provide any explicit data to indicate that they were born in Colorado. Statistical models generally result in probabilistic outputs (0%-100%) rather than absolute certainty, which means some authors may be considered “probable” tribe members using such techniques. This probability may optionally be used in weighting their documents, postings, or social media data for its contribution to the tribe analysis (e.g., analysis of common interests and the like). Using these and other similar factors to increase the size of a tribe is typically beneficial because increasing the amount of sample data in a tribe and increasing or accounting for the accuracy of the tribe membership data may significantly improve the accuracy of conclusions drawn from the tribe analysis including generated intelligence that is reported out to clients and others.

With the above discussions understood, it may now be useful to provide more specific examples of implementations and/or embodiments of the tribe analysis tool so as to more fully explain exemplary methods and techniques for accomplishing the functions of the invention. The following examples generally explain techniques with relation to obtaining data from the blogosphere but these or other similar techniques may be used for other social media. For example, the tribe analysis may involve one or techniques for performing data extraction or extracting tribe data from the blogosphere. Data extraction may be performed using a set of selection criteria, such as a Boolean formula of key phrases, metadata (e.g., anchors/links, profile attribute, date, host, thread, etc.) and/or, in some cases, classifiers previously run on the tribe document set (e.g., determining age (e.g., gen-x), gender (e.g., male), etc.). The data extraction may continue with selecting objects, posts, or other online content that match the selection criteria (e.g., posts that contain a certain phrase, posted after a certain date, where the author is female, and so on). Data extraction may then include selecting the users who have authored the postings. These people/users/authors will make up the tribe. Next, data extraction may include selecting, retrieving, and storing all the postings of all people in the tribe. These postings per user will be the tribe data set for further analysis.

The tribe analysis may further include phrase extraction. Given the postings of the tribe members, phrase extraction generally involves processing this tribe data set to extract significant, representative phrases/terms (single word or multi-word). For example, in a document about cooking, “temperature” may be considered a significant phrase but “last month” may not be extracted as a significant phrase. In some implementations, the tribe analysis tool or method considers both noun phrases (e.g., “stuffed turkey” in the cooking tribe example) and verbs (e.g., “roasting”). The noun phrases will generally refer to the domain objects while the verbs refer to the actions performed over the domain objects. The following are examples of ranked phrases for a dataset of all the blog postings of authors discussing organics food:

Single word phrases include: pasture-raised, soupspoons, soup-like, low-carbing, cactus, fine-mesh, etouffees, welschriesling, branzino, bakingsheet, vinography, vegetarian-fed, unvegan, under-the-sink, un-flavorful, tofu-based, tea-smoked, tablesps, sumosalad, soy-free, shiraz-cabernet, savoriness, sauce-like, risottos, religious-conservative, meat-loving, instant-coffee, freeradicals, caffeine-less, brothy, bread-baking, beef-like, un-sweet, real-food, raspberry-almond, pre-freeze, food-lovers, foccaccia, eggs-and-sugar, broccoli-cheddar, al-dente, locally-grown, yeasted, veganize, tenderizes, rotisseries, reduced-sodium, overbaked, yo-yo-yogurt, and the like.

Two word phrases may include: foods pick, vegan version, salt dash, processed soy, flat rolls, szechwan cuisine, organic producers, mix gently, mild curry, herb salad, crushed macadamia, complex wine, best absorption, yogurt mix, fruit coffee, wine aromas, whole-food sources, vinegar taste, taste award, romaine hearts, regular supermarket, real dairy, popular dessert, pink wines, pasta mixture, organic egg, organic brands, and the like.

Three word phrases may include: whole foods stores, stews and soups, organic corn chips, crushed macadamia nuts, weight reducing diet, sweetened with cane, small red pepper, sensible eating plan, peeled fresh ginger, new peanut butter, ingredients I need, individual dietary needs, fruit and honey, delicious Indian food, cheese and herbs, best taste award, bake until firm, all-natural whole-food vitamins, sweet red bean, serving red wine, salad with mint, pressure stayed normal, potassium and fiber, popular after dinner, point and eat, pineapple delight smoothie, oven roasted tomatoes, organic heirloom tomatoes, large hot dogs, creating gourmet meal, blue Danube wine, beans with rice, avoid saturated fats, yogurt covered pretzels, writing about feminist, whole wheat couscous, whole wheat breads, whisk in sugar, whipping egg whites, vibrant and healthy, vanilla buttercream frosting, understanding free radicals, turkey sandwich supreme, turkey sandwich platter, traditional Chinese diet, tomatoes in season, teaspoon coarse salt, Swiss cheese fondue, sweet decorative icing, sweet and crunchy, sugar and egg, strong green tea, strawberry orange sorbet, steel mixing bowl, squeeze excess moisture, spicy ground beef, specialty store services, southern European wine, sour cream chocolate, soldiers on steroids, sharp paring knife, savor each mouthful, salad with onions, roasted green chiles, roasted cherry tomatoes, roast leg lamb, and the like.

Four word phrases may include: went to whole foods, stores like whole foods, serve with crusty bread, pan with removable bottom, lunch at whole foods, green vegetables like spinach, being at room temperature, whole foods grocery store, Starbucks and whole foods, simmer over moderate heat, creating gourmet meal plans, winery in Napa valley, vegetarian cooking for everyone, vegetable or chicken stock, various fruits and vegetables, use high fiber foods, try other countries bbq, track everything you eat, tickle your taste buds, take your next bite, specialty coffees including espresso, smoking and drinking wine, send her some love, saucepan over moderate heat, revealed omega-3 fatty acids, respiratory and cardiac arrest, and the like.

Of course, these are just some examples of the use of single, two, three, and four word phrases that may be used in one implementation, and these are only intended to be illustrative of the process. Those skilled in the art will also understand that this portion of the analysis may involve identifying phrases that include words, bi-grams, tri-grams, and n-grams. The invention is not limited to a particular phrase extraction technique or, for that matter, to the use of phrase extraction in the tribe analysis.

The tribal analysis may then further include ranking of phrases. For example, given a set of possible phrases, order them by relevance for a tribe. This analysis or process may make use of a general (e.g., background) collection. In one embodiment, phrases that are mentioned more in the tribe and less in the general collection are considered significant for the tribe. The more times mentioned in the tribe and the less in the general collection the higher the ranking for the phrase. This can be achieved for example using the well-known TF×IDF framework, where TD is term frequency and IDF is inverse document frequency.

Tribe analysis may also include clustering. Here, clustering of the discussion and assigning a label to the clusters may be thought of as a form of summarization. The analysis tool and its routines may cluster on different kind of objects or data such as the documents in the tribe dataset, the phrases (noun phrases or verb phrases), the named entities, and the like. The tribe analysis may be configured to do different kinds of clustering such as one or more of the following: (1) flat (one level clusters/groups where the set is broken into subsets A, B, C) or (2) hierarchical clustering (where the set is broken into subsets A, B, C, . . . ; where the set A itself is broken into its own clusters A₁, A₂ , . . . , Aₙ; and the like).

The following is an example of clustering of phrases into groups. There are several steps. First, heuristic clustering may be applied by merging phrases that share the same main nouns but may have different adjectives (Caesar salad and Greek salad will now be grouped for example). Second, an ontology may be used to group objects from the same semantic category (cherries and peaches will now be grouped for example). Third, statistical clustering may be applied. Fourth, significant terms (e.g., phrases) may be automatically identified for each cluster (e.g., using scores like raw counts, TF×IDF weights, and/or the like for them or for the classes they belong to). Also, new terms which do not appear in the tribe documents can also be automatically suggested using a thesaurus or other documents. Fifth, the clusters may be assigned labels (e.g., term or terms with the highest score(s)). In some cases, it is expected that the user of the system may modify the set of terms in the cluster (e.g., add new terms, remove existing terms, and so on) as well as to provide a label for each cluster.

The following are example clusters with the clusters having been, in this case, assigned labels manually. A first cluster may be Cluster 1 (Label: environment) with the following significant terms/phrases: energy oil global gas warming environment power change fuel earth climate environmental waste carbon green planet need water solar electric. A second cluster may be Cluster 2 (Label: cooking) with the following terms/phrases: chocolate cream cake ice butter cookies dessert cookie peanut sugar vanilla chips sweet taste dark banana whipped flavor chip nuts. A third cluster may be Cluster 3 (Label: healthy eating) with the following terms/phrases: weight diet fat eating eat calories sugar food healthy foods pounds lose high low health loss meals nutrition gain carbs. A fourth cluster may be Cluster 4 (Label: religion) with the following terms/phrases: god church jesus christian faith bible christ religion word believe lord religious heaven christians holy sin catholic pray prayer father.

The tribe analysis may further include scoring users/tribe members by these clusters. An example cluster above was a set of phrases. A tribe member may have postings which may mention the cluster phrases. The goal of this portion of the tribe analysis is to decide which users are associated with a cluster. Then we can pick only those users with the highest scores. This will allow us to make determinations or create intelligence along the following lines: XX% of the tribe discuss topic Y where Y is the label of the cluster. In this analysis, the following parameters are taken into consideration when deciding if a user discusses the topic of the cluster: (1) count of the occurrences of the cluster phrases in all the postings of the user; (2) frequency (normalized counts); (3) time because occurrences in the past may be considered to contribute less. If it is assumed that the posting is associated with a normalized date, the tribe analysis may involve computing how many days ago a posting has happened.

The tribe analysis may further include scoring sentences by clusters. In this step or subroutine it is desirable to choose the sentences relevant for a cluster so that the presence of a subtribe can be demonstrated or determined. Scoring sentences by clusters may also facilitate the understanding of the discussions in the tribe. The tribe analysis may also involve user of named entity (NE) components. An NE component may be adapted to find mentions of objects belonging to certain semantic categories. For example, such an NE component may draw conclusions like: 30% of the organic tribe mention Britney Spears, and an example of another semantic class location is: 30% of the tribe discussing tornadoes mention Oklahoma. Other semantic categories include: celebrities; brands; politicians; and magazines. In other cases, as discussed above, clustering and scoring is performed based on phrases and not by sentences.

Still further, the tribe analysis may involve link analysis. A tribe can be analyzed in terms of terms of the link structure among its tribe members. A link between tribe members can include: (1) a tribe member posting to a blog of another tribe member; (2) a tribe member quoting another tribe member; (3) tribe members sharing outgoing links, references to entities (politicians, celebrities, TV shows, movies, etc.); and the like. In one embodiment, link analysis involves measuring degree distribution, clustering community, and centrality of actors in the graph.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. As was described above, tribe analysis, which may involve machine learning algorithms, provides intelligence or a depth of understanding of blog and other authors belonging to a particular tribe/subtribe and their posted content such as buzz volume (e.g., number of mentions per week by topic), sentiment (e.g., percent of positive, negative, and neutral statements within a topic), age of speaker (e.g., authors of a tribe that are in Gen-Y, Gen-X, Boomer or other generations or age/generation may be used as a tribe selection criteria), gender of speaker (e.g., percent of males and females in a tribe or, again, this may be a selection criteria), or the like. The tribe analysis may be supervised such as with standard topic analysis that may process identified tribe authors with algorithms examining key (or predefined) topics to provide insight or intelligence (such as tribe member attitudes, behaviors, and the like). Supervised analysis may also use client-provided or identified interests which are then fed or forced into the algorithms processing the aggregated tribe postings to identify common interest, sentiments, and the like. Tribe analysis may also involve unsupervised clusters analysis. For example, such analysis may use natural language processing and/or machine learning algorithms to identify topics of conversation within a tribe (or their aggregated social media data) such as most frequent topics during a certain time period. Note, reporting of intelligence (such as gender makeup of a tribe) is typically provided along with similar information about all authors or a larger portion of the contributors of the social media data (such as gender makeup of all authors in the blogosphere).

A variety of techniques may be used to collect the social media data and to perform unsupervised analysis of common interests or topics of a group (and/or clustering). The following discussion provides specific examples of techniques that may be used to implement an embodiment of the invention, and additional information may be found in U.S. Pat. Appl. Publ. No. 2006/0053156 to Kaushansky et al., which is incorporated herein by reference in its entirety.

Regarding data collection or gathering and aggregating the social media data for the authors (or speakers). Weblogs or blogs may be accessed to obtain data that resides on a network, which may include opinion data, commentary, and the like. The invention is also useful for accessing other sources and types of online data, and exemplary sources of useful data include weblogs, web sites, chat rooms, message boards, Usenet groups, electronic mail, instant messaging (IM), podcasts, as well as video streams, audio streams and the like that have been transformed to a textual representation, and other sources of data that has been made available on a communications network such as, but not limited to, the Internet.

The tribe analysis tool may utilize a market intelligence service that crawls and analyzes the information from various sources at which the online community is represented in a network. In particular embodiments, for example, the tribe analysis tool uses natural language processing (NLP) and machine learning algorithms to provide a synopsis of what is being said as well as the explicit and/or implied attributes of the speaker or author to provide a new and untapped source of marketing research and competitive intelligence. As used herein, “speaker” or author is intended to refer to the person who authors or contributes information to the online community. Speaker attributes include gender, age, education, political affiliation, income, ethnicity, sexual preference, education, household size, family size, community size, home ownership, and other attributes that describe something about the speaker/author of information obtained from online sources. Some speaker attributes may by explicitly provided by the speaker. While explicitly provided information is useful, the tribe analysis may expand on this by providing techniques for implying speaker attributes using techniques such as linguistic analysis. In one embodiment, the centralized market intelligence service is provided with one or more network-connected servers. The service provides data collection processes that function to gather data from the online community, analysis processes that function to provide linguistic, statistical, or other analysis functions, and reporting processes that function to present organized and analyzed information to users. Additionally, the market intelligence service includes user interface processes that allow users to access the system and specify criteria that define desired market intelligence reports or tribe analysis reports.

The tribe analysis system may be implemented in a networked computer environment such as within an online community including individuals who form the online community by contributing information in the form of commentary to various online information services such as weblogs implemented by one or more web servers, newsgroup posting via Usenet servers, chat postings via servers, message board postings via message boards, and the like. The tribe analysis tool may utilize or be run on a server or other device that is coupled to be accessed by users (e.g., clients and administrators) via a network. Users can submit report requests to the tribe analysis tool and its server and receive generated reports, for example, using Internet Protocol (IP) messages (e.g., HTTP, SMTP, and the like). Users may be the ultimate consumer of an intelligence report or may represent a specialist who generates intelligence reports for an ultimate consumer. The tribe analysis server and run tools/modules may include processes to implement a network interface, implement a user interface for communicating with users, crawler processes for collecting unstructured data from the various information sources, analysis processes for analyzing the unstructured data, and report generation processes for formatting analyzed data in to a form suitable for presentation to users.

Data collection or aggregation of social media data may involve collecting or capturing unstructured data from the various information sources. The service provides data collection processes such as web crawlers that actively seek out data (i.e., pull data) from the online community using the interfaces implemented by the various services that provide that data. Alternatively, data may be pushed from the various services to the centralized market intelligence service using data provider processes that execute in conjunction with the various online community services. Web crawling technology is available from a variety of sources such as Semantic Discovery and the like. The data collection mechanisms may vary depending on the type of online community service that is being examined. Web crawlers are suitable for sources such as weblogs, web sites, message boards and newsgroups, whereas other tools may be more appropriate to obtain data from email and chat sources. Real simple syndication (RSS) feeds may also be used to collect information by notifying a system of changes in particular information sources such as weblogs and web sites. Using notifications from an RSS feed allows the system to focus data collection processes on sources that have changed and specifically to collect new or modified information without. Of particular interest to tribe analysis is information that represents unsolicited information such as unsolicited opinions, commentary, analysis, observations, reviews, ratings and the like (e.g., unstructured social media data), which is often present in the form of a text message posted alone or as part of a conversation thread. By “unsolicited” it is meant that the information that is collected is not solicited by the system performing the collection. Information may, in fact, be in the form of a question-response thread between multiple third parties who are soliciting each other's opinions. However, for purposes of the present invention, such information is considered “unsolicited” because it retains the important characteristic that it is not affected by prompting from a person or organization that is studying the information. It may be desirable that the data be collected together with pointer or link information that provides a reference to the source of the information. This pointer may take the form of a uniform resource locator (URL) that can be used as a link back to the original source of the information. Other information such as date, length, screen name of the speaker, conversation thread identification, and the like may be captured along with the data itself.

Analysis of this gathered social media data may involve using natural language processing to identify interests of an individual tribe member and/or of a tribe of speakers or authors. For example, the present invention enables users to mine and understand the online community and turn raw public opinion about companies, their products and their competition into marketing insight or “intelligence.” The captured natural language text is analyzed to gain understanding of its meaning and generate a machine response. In some cases, raw data is captured in the form of a text file that contains data representing one or more members of an online community (i.e., one or more speakers or authors). The raw data may be maintained in the form of records such that each record is associated with a single speaker. Accordingly, it may be necessary to split files that represent multiple speakers into multiple records that each represents a single speaker. In some implementations, captured text is pre-processed to distill out the words or phrases that have significance to a particular task and remove symbols that are not useful. In some cases, preprocessing may involve removing punctuation, capitalization, and common words such as conjunctions, prepositions, definite and indefinite articles and the like. Preprocessing may identify word stems and account for prefixes, suffixes, and endings (morphemes). Preprocessing results in a text file that is richer in meaningful content, but it should be done in a manner that minimizes the risks associated with removing meaningful data. A number of algorithms and tools exist to assist linguistic specialists in developing preprocessing techniques that are suitable for a particular application, thereby improving the quality of subsequent analysis.

Developing a preprocessing tool for a particular application may require fine-tuning the preprocessing tool to a specified language, vocabulary vernacular or dialect native to the source of the textual information in order to efficiently filter out supplementary words and morphemes. For example, some blogs may include frequent posts that include acronyms specific to a particular topic, or abbreviations (e.g., using “IMHO” to mean “in my humble opinion”). Such domain-specific acronyms and abbreviations may be useful “as is” or may be handled by teaching the analysis tools to associate a meaning with the acronym, by expanding the abbreviations to their full word representation, translating the acronym/abbreviation into another word or phrase that represents the meaning, or other similar technique that preserves meaning while aiding subsequent analysis. Preprocessing may be implemented by conventional computer algorithms as well as adaptive or learning computer systems and neural network systems. Preprocessing may operate on whole words, phrases, word fragments, character n-grams, word-level n-grams or other character grouping used in natural language processing.

Captured or aggregated social media data may also benefit from normalization before and/or after preprocessing. Particularly when working with data sources of varying length, longer entries, or entries that repeat certain words frequently may appear to be more statistically significant to automated analysis software. Normalization is an automated process implemented according to algorithms or by neural network software/hardware to give weight to various words, phrases, or entire entries so as to account for known characterizes that will affect downstream semantic analysis.

In particular implementations of the present invention, linguistic analysis (such as to perform interest analysis or to perform clustering) involves two distinct components. A first component involves processes that identify and/or imply speaker attributes. A second component involves processes that identify attributes of the speech and that derive meaning from the captured data. The attribute processes operate on individual records to identify speaker characteristics such as age, gender, national origin, political preference, geographic background, and other speaker attributes. The record may contain information that explicitly states the attribute information such as in a signature line that states the speaker is male or female. More often, the speaker attribute information is implied from information in the message body. For example, a signature line that indicates “Sarah” would have a high probability of representing a female speaker. Speaker attribute implication may involve complex analysis of the vocabulary, sentence complexity, source of the message, message context, or other information.

Speaker attributes may refer not only to individual attributes such as gender, nationality, and the like, but also to roles or areas of expertise. Like other attributes, a speaker's role or area of expertise may be explicit in a message (e.g., a signature line that indicates “V.P. of Marketing”) or may be implied or derived by more sophisticated analysis (e.g., reference to domain specific acronyms such as PPC and PPCSE imply internet marketing expertise). Classification of speakers by roles and/or areas of expertise can be as useful as classification by personal attributes, especially when attempting to gauge the veracity or accuracy of speaker. In performing speaker attribute analysis, it may be useful to quantify “unique voices” represented in the captured data. A unique voice corresponds to a unique, particular speaker. In some cases it is useful to adjust the weight given to a collection of messages based on whether those messages represent a number of unique voices or a single, repetitive voice. A collection of messages may include multiple messages from a single speaker in which case all of the messages are associated with a single unique voice. In contrast, the collection of messages may include multiple messages where each speaker is unique and so each message is associated with a particular unique voice. In practice there is often a mix in which some unique voices are represented by one or a few messages and other voices are represented by many repetitive messages.

In some cases of tribe analysis, it may also be useful to understand the contribution of “new voices” to a conversation. A topic may involve conversations that extend over a months or years. At various times, there may be an increase in the number of new voices (i.e., new speakers) that are contributing to the conversation. For example, when analyzing marketing information about a particular product or service an increase in the number of new voices that are contributing opinions about that product or service indicates market activity that may suggest more attention or more detailed analysis of those conversations is in order. The speaker analysis features of the present invention enable identifying new voices and thereby quantifying increases and decreases in the number of new voices over time. Also, the sentiments expressed by new voices can be tracked separately from “older” voices to indicate changes in expressed opinions.

Embodiments of the tribe analysis tool may also perform a semantic analysis of each message to determine attributes of the speech itself. For example, an attribute might indicate a message thread to which the message belongs (e.g., a numerical thread ID or a text thread name). Also, attributes might indicate semantic characteristics that can be implied from the text. For example, an attribute of the speech might indicate whether the tone of the speech is positive or negative. In some embodiments, the analysis tool uses statistical models to determine a confidence level for an implied attribute. A low confidence level will indicate that the attribute is less likely to be accurate. In this manner, in particular messages where the confidence level is below a preselected threshold (e.g., less than 50%), the attribute for that message will be indicated as indeterminate. The messages may be saved along with the attribute information, confidence level for each attribute, and a pointer to the source of the message in a database for future use in reporting.

Interest analysis and clustering may involve using a clustering model that represents relationships between messages. Messages may be processed to determine a semantic relationship with other messages that indicates a degree of similarity between messages. For example, three dimensions of similarity may be measured, but any number of dimensions may be used depending on the nature of the inquiry, and the meaning of each dimension can be defined to satisfy the requirements of a particular application. A number of techniques are known that perform semantic analysis on data sets comprising text. In an exemplary analysis, messages are analyzed to identify one or more topics that are associated with each message. This topic information can be associated with the message as an attribute, as described above. In one example, clusters include messages of pre-selected similarity are identified within the topic. Optionally, sub-clusters may be identified within the clusters by identifying messages with even greater similarity. Alternatively, sub-clusters can be identified using semantic dimensions different from those used to identify clusters. Hence, a cluster might be defined as a group of messages within a topic named “Presidential Election” that are similar in that they deal with environmental issues (e.g., have a high occurrence of words/phrases associated with environmental issues). The members of a cluster may be sub-clustered to identify positive-toned and negative-toned sub-clusters using semantic dimensions that reflect tone of speech. The above discussion is typical of unsupervised analysis of social media data.

In some cases, analysis is performed in a more supervised manner. For example, analysis and report generation may be performed in response to a report request, which can be a “live” request made immediately by a user or a stored request that runs periodically. A report request identifies one or more topics, features of interest within that topic, and attributes of interest within features (provides client interest direction). As noted above, it is also contemplated that “self-organized” or unsupervised reports on a particular topic might also be useful in which features and/or attributes are not specified. In such cases, the clusters and/or sub-clusters can be used to provide features and attributes, and reports of unsupervised common interests or topics of interest to a tribe allow one to identify what issues are being discussed by the online community without a priori knowledge of what those issues are.

When features/topics/interests/issues are specified in a report request, the messages associated with the specified topic in the aggregated tribe social media data (over a particular time period) are analyzed to identify messages having sufficient semantic proximity to the request-specified feature. In the context of a product report, a topic might be a particular product such as an automobile. The request might specify features such as quality, price, reliability and the like. Messages within the topic that have words, phrases and/or attributes that indicate a similarity to the features are then selected and added to the appropriate feature set. Similarly, attribute analysis involves identifying messages within each feature set that are semantically close to a request-specified attribute. Continuing the example above, appropriate attributes for the “quality” feature set might include manufacturing, interior, exterior, engine, and the like. In the case of the price feature set, attributes such as “too high” or “competitive” might be defined by a request. Messages within the feature sets that have words, phrases and/or attributes that indicate a similarity to the attributes are then selected and added to the appropriate attribute set.

The tribe analysis reports may take many forms. For example, for a tribe, the reports may provide a breakdown and segmentation by age, gender, or other attributes of the population expressing viewpoints and opinions regarding your client's products or topics of interest. For a tribe, the reports may also provide a breakdown and segmentation by age (and often gender) of the population expressing viewpoints and opinions regarding the products of your client's competition. The tribe analysis report may also provide a summary of the raw opinion data with a determination as to the positive or negative opinion on the product or topic and further include active URLs from which a user can further view the opinions of the “bloggers” with each blogger designated by the segment of the population they represent. Typically, a tribe analysis report will include cumulative graphs and tracking of opinion directions and perspectives of the tribe in aggregate and of subtribes. The report may also include competitive comparisons enabling clients or users to compare opinions and perspectives of their products or topics to those of their competitors for a particular tribe or subtribe.

We claim:

1. A computer-based method for generating intelligence from social media data available on the Internet or other communications networks, comprising:
providing a server running a tribe analysis tool on a digital communications network;
accessing a set of social media data with the tribe analysis tool, the social media data being associated with a plurality of authors;
operating the tribe analysis tool to identify members of a tribe from the plurality of authors by processing the set of social media data to determine the authors associated with portions of the social media data that satisfies a set of tribe membership criteria;
determining with the tribe analysis tool a set of common interests for the identified members of the tribe by processing a subset of the social media data associated with the authors that are the identified members of the tribe; and
generating a report with the tribe analysis tool for the tribe including information related to the set of common interests.

2. The method of claim 1, wherein the set of social media data comprises data from a set of web logs served on the digital communications network.

3. The method of claim 2, wherein the subset of the social media data comprises postings in the set of web logs by the identified authors.

4. The method of claim 1, wherein the set of tribe membership criteria comprises one or more criteria selected from the group consisting of: age; gender; sentiment regarding a topic; behavior; mentioning particular phrases in a posting; blog host; political affiliation; religious characteristics; sexual preferences; race; geographical location; similar content to which authors point; marital status; family size; number of children; role in a social media; influence in the social media; influencer characterization; education; income; occupation; purchasing habits; social role; social label; sports interests; sports participation; hobbies; personality; brand loyalty; multimedia content; metadata; and favorite entertainment programs.

5. The method of claim 1, further comprising determining a sentiment for each of the identified members of the tribe for each of the common interests, aggregating the determined sentiments, and including the aggregated sentiments in the report with the set of common interests.

6. The method of claim 5, further comprising operating the tribe analysis tool to compare the common interests of the tribe and the aggregated sentiments regarding the common interests with interests and sentiments of a tribe with differing membership than the tribe or of the plurality of authors providing the social media data.

7. The method of claim 1, further comprising determining with the tribe analysis tool common interests for the plurality of authors of the set of social media data and then determining differences between the common interests of the plurality of authors and the set of common interests of the members of the tribe.

8. The method of claim 1, further comprising after a period of time repeating the operating of the tribe analysis tool to identify a new membership of the tribe.

9. The method of claim 1, wherein the accessing of the social media data comprises aggregating in a data store data posted by the plurality of authors on social media on the digital communications network, the method further comprising repeating the accessing step after a period of time to include additional postings by the plurality of authors to the social media.

10. The method of claim 9, wherein the determining of the set of common interests is performed by comparing a set of predefined interests to the subset of the social media data to determine whether one or more of the predefined interests is a common interest for the identified members of the tribe.

11. A method for gathering intelligence from data available on web logs or blogs, comprising:
with an analysis tool run by a processor of a computer, aggregating a set of blog data posted by a plurality of authors;
defining a set of the authors with the analysis tool to be members of a tribe;
operating the analysis tool to collect and store in memory the blog data for a period of time that is associated with the members of the tribe;
processing the tribe blog data for each tribe member to determine a set of interests;
with the analysis tool, comparing the sets of interests to determine a set of common interests for the tribe; and
with the analysis tool, outputting a report including data related to the determined set of common interests.

12. The method of claim 11, wherein the defining of the set of the authors that are the tribe members comprises retrieving from memory a membership criteria and then processing the set of the blog data posted by the plurality of authors with the membership criteria.

13. The method of claim 12, wherein the membership criteria is compared to phrases in the blog data and comprises one or more criteria selected from the group consisting of: age; gender; sentiment regarding a topic; behavior; mentioning particular phrases in a posting; blog host; political affiliation; religious characteristics; sexual preferences; race; geographical location; similar content to which authors point; marital status; family size; number of children; role in a social media; influence in the social media; influencer characterization; education; income; occupation; purchasing habits; social role; social label; sports interests; sports participation; hobbies; personality; brand loyalty; multimedia content; metadata; and favorite entertainment programs.

14. The method of claim 11, wherein the data related to the determined set of the common interests provided in the report comprises a sentiment for the member of the tribe for each of the common interests.

15. The method of claim 11, wherein the data related to the determined set of the common interests provided in the report comprises results of a query regarding a topic applied to the tribe blog data.

16. The method of claim 11, wherein the data related to the determined set of the common interests provided in the report comprises intelligence related to a comparing of the determined set of common interests to common interests of another tribe with at least some differing members.

17. The method of claim 11, wherein the data related to the determined set of the common interests provided in the report comprises trending data indicative of changes make up of the authors defined to be the members of the tribe.

18. A computer readable medium for performing analysis of data available over a network in one or more social media systems, comprising:
computer readable program code devices configured to cause a computer to effect retrieving social media data from memory accessible via the network;
computer readable program code devices configured to cause the computer to effect applying a membership criteria to the retrieved social media data to identify a subset of authors of the retrieved social media data;
computer readable program code devices configured to cause the computer to effect identifying and storing in memory a portion of the retrieved social media data associated with the subset of authors; and
computer readable program code devices configured to cause the computer to effect processing the portion of the social media data to determine a set of common interests of the subset of authors.

19. The computer readable medium of claim 18, wherein the processing to determine the set of common interests comprises first identifying interests of each of the authors and second comparing the interests of all the authors to identify the set of common interests for the subset of authors.

20. The computer readable medium of claim 18, further comprising computer readable program code devices configured to cause the computer to effect determining a sentiment of the subset of authors regarding each of the common interests, determining a sentiment regarding the common interests by authors of the retrieved social media, and comparing the two sentiments for each of the common interests to determine differing ones of the sentiments.

21. The computer readable medium. of claim 18, further comprising computer readable program code devices configured to cause the computer to effect determining a level of concern for the subset of authors regarding a topic by processing the portion of the social media data, wherein the portion of the social media data includes postings made over the network during a defined period of time.

22. The computer readable medium of claim 21, wherein the social media data comprises data from a set of web logs served on the network.

23. The computer readable medium of claim 22, wherein each of the subset of authors is identified by a web log URL and the web log URLs of the authors is used in the identifying of the portion of the social media data.

24. A method for generating intelligence from social media data available on the Internet or other communications networks, comprising:
accessing a set of social media data associated with a plurality of authors;
identifying members of a tribe from the plurality of authors by processing the set of social media data to determine the authors associated with portions of the social media data that satisfies a set of tribe membership criteria;
determining a set of common interests for the identified members of the tribe by processing a subset of the social media data associated with the authors that are the identified members of the tribe; and
generating a report for the tribe including information related to the set of common interests.

25. The method of claim 24, wherein the set of social media data comprises data from a set of web logs served on the digital communications network.

26. The method of claim 25, wherein the subset of the social media data comprises postings in the set of web logs by the identified authors.

27. The method of claim 24, further comprising determining a sentiment for each of the identified members of the tribe for each of the common interests, aggregating the determined sentiments, and including the aggregated sentiments in the report with the set of common interests.

28. The method of claim 27, further comprising comparing the common interests of the tribe and the aggregated sentiments regarding the common interests with interests and sentiments of a tribe with differing membership than the tribe or of the plurality of authors providing the social media data and reporting results of the comparing.

29. The method of claim 24, further comprising after a period of time repeating the identifying step to determine a new membership of the tribe.

30. The method of claim 24, wherein the accessing of the social media data comprises aggregating data posted by the plurality of authors on social media on the digital communications network, the method further comprising repeating the accessing step after a period of time to include additional postings by the plurality of authors to the social media.

31. The method of claim 30, wherein the determining of the set of common interests is performed by comparing a set of predefined interests to the subset of the social media data to determine whether one or more of the predefined interests is a common interest for the identified members of the tribe.
